(19) United States
(12) Patent Application Publication
(10) Pub. No.: US 2022/0004175 A1
(43) Pub. Date: Jan. 6, 2022

(54) Apparatus and Method for Computer-Implemented Determination of Sensor Positions in a Simulated Process of an Automation System

(71) Applicant: Siemens Aktiengesellschaft, Muenchen (DE)

(72) Inventors: Lars JORDAN, Poing (DE); Hermann Georg MAYER, Prien am Chiemsee (DE)

(21) Appl. No.: 17/288,018

(22) PCT Filed: Oct. 25, 2018
(86) PCT No.: PCT/EP2018/079277

§ 371 Date: Apr. 23, 2021

(51) Int. Cl. G05B 19/418

(52) U.S. Cl. CPC G05B 19/41885; G05B 19/41835; G05B 2219/24097; G05B 2219/25184; G05B 2219/23258; G05B 2219/40616

(57) ABSTRACT

A method for computer-implemented determination of sensor positions in a simulated process of an automation system, wherein the simulated process includes a digital process description of an automation task to be executed by components, the process description including a movement specification describing the movement of the components during execution of the automation task, and including a digital sensing description defining a sensing task to be performed by a sensor during execution of the automation task and at least one sensing constraint of the sensor and the sensor volume of the sensor.

### CROSS-REFERENCE TO RELATED APPLICATIONS

This is a U.S. national stage of application No. PCT/EP2018/079277 filed 25 Oct. 2018.

### BACKGROUND OF THE INVENTION

### 1. Field of the Invention

The invention relates to a method for computer-implemented determination of sensor positions in a simulated process of an automation system.

### 2. Description of the Related Art

The complexity of sensors in automation systems, such as manufacturing plants, is increasing. Particularly, the geometric dimensions and sensing restrictions of sensors have increased by employing camera systems or by using combined sensors to enable sensor fusion. Hence, for processes of an automation system simulated on a computer, there is a need to analyze those processes to determine whether the placement of corresponding sensors for performing a predetermined sensor task is at all possible within the respective process.

### SUMMARY OF THE INVENTION

In view of the foregoing, it is therefore an object of the invention to provide a computer-implemented method that provides the ability to determine possible sensor positions for performing a sensing task in a simulated process of an automation system.

In the method in accordance with the invention, the simulated process of the automation system includes a digital process description of an automation task to be executed by a number of components of the automation system. In a preferred embodiment, the number of components comprises at least one robot. The process description includes a movement specification describing the movement of the number of components during the execution of the automation task. The movement specification may be provided based on a kinematic model of the number of components. Such movement specifications are known per se from the prior art. The method of the invention also processes a digital sensing description, where the sensing description defines a sensing task to be performed by a sensor (e.g., the detection of a specific object at a predetermined position within an automation cell) as well as a number of sensor parameters of the sensor means. For example, the sensor may comprise at least one camera for detecting one or more objects handled by the number of components. The number of sensor parameters comprises one or more sensing constraints of the sensor. A sensing constraint may be described by a condition that has to be fulfilled so that the sensing task can be performed. In the case of a camera, a sensing constraint may refer to the focal length of the camera where the camera has to be placed within a spherical shell around the object to be detected where the spherical shell Includes as a radius the focal length of the camera.

In a step a) of the method in accordance with the invention, a placement volume based on the movement specification is determined, where the placement volume lies within a predetermined area surrounding the number of components. This area may, e.g., be the volume of an automation cell of an automation system where the simulated process is executed within the automation cell. Furthermore, the placement volume does not overlap with the number of components and any other object (excluding the sensor) during the execution of the automation task.

In a step b) of the method in accordance with the invention, a sensor arrangement volume is determined, where the sensor arrangement volume defines a volume of sensor positions of the sensor. The sensor positions may, e.g., be defined based on the center of gravity of the sensor. The sensor arrangement volume is defined such that the sensor volume of the sensor lies at each sensor position within the sensor arrangement volume completely inside the placement volume and that the sensing task can be performed during the execution of the automation task at each sensor position within the sensor arrangement volume by the sensor with respect to the number of sensing constraints.

The method of the invention provides a straight forward computer-implemented method for determining possible sensor positions by calculating a volume not covered by the components of the automation system. Hence, it is guaranteed that the volume of the sensor does not interfere with the components of the automation system. Furthermore, the method considers sensing constraints given for the respective sensor to ensure that the sensing task can indeed be performed at a respective sensor position. Preferably, a warning is output via a user interface and particularly via a visual user interface in cases in which a sensor arrangement volume cannot be identified by the method of the invention.

In a preferred embodiment of the invention, at least one sensor position is identified within the sensor arrangement volume based on one or more optimization criteria. Those optimization criteria may be defined differently depending on the circumstances. For example, an optimization criterion may be a short cable length connecting the sensor with a plug or an optimization criterion may refer to a good accessibility of the position for mounting the sensor. In accordance with the presently contemplated embodiment, preferred sensor positions within the sensor arrangement volume are determined based on desired criteria.

In a particularly preferred embodiment, the sensor arrangement volume and/or the at least one sensor position identified by optimization criteria are output via a user interface. Particularly, this information is shown on a visual user interface, e.g., a display. Preferably, the visualized sensor arrangement volume and/or the at least one visualized sensor position are highlighted within a picture showing the relevant components of the automation system.

In a preferred embodiment of the invention, the determination of the sensor arrangement volume based on the above step b) comprises the following sub-steps:

determining an intermediate volume defining a volume of sensor positions of the sensor, where at each sensor position within the intermediate volume the sensing task can be performed by the sensor with respect to the number of sensing constraints without considering the placement volume;

determining the intersection between the intermediate volume and the placement volume; and

determining as the sensor arrangement volume that area within the intersection where the sensing task can be performed by the sensor with respect to the number of sensing constraints considering the placement volume (e.g., no obstructions in the detection area of the sensor during sensing) and where the sensor volume lies completely within the placement volume.

In another particularly preferred embodiment, additional steps are performed in cases in which a sensor arrangement volume cannot be identified in step b). Those steps enable the determination of sensor positions under the assumption that the sensor is movable. The embodiment comprises the following:

associating with the sensor a mechanical mechanism for moving the sensor, where the sensor and the mechanical mechanism form a movable sensor platform, where an operation time is assigned to the movable sensor platform, where the operation time is the time for moving the sensor from a first position (e.g., an idle position) to a second position that is a sensing position, performing the sensing task by the sensor in the sensing position and moving the sensor back to the idle position;

determining a movement volume of the movable sensor platform, where the movement volume is the volume covered by the movable sensor platform during the operation time of the movable sensor platform; and

dividing the automation task into a plurality of subsequent sub-tasks, where each sub-task is associated with a sub-task time needed to execute the sub-task.

For each sub--task having a sub-task time greater than or equal to the operation time of the movable sensor platform, the following sub-steps are performed:

determining for the respective sub-task a sub-task placement volume based on that part of the movement specification which describes the movement of the number of components during the execution of the respective sub-task, where the sub-task placement volume lies within the predetermined area surrounding the number of components and where the sub-task placement volume does not overlap with the number of components and any other object (excluding the sensor platform) during the execution of the respective sub-task; and

determining one or more mount positions of the movable sensor platform, where at each mount position the movement volume of the movable sensor platform lies completely within the respective sub-task placement volume and the sensing task can be performed during the execution of the respective sub-task by the sensor with respect to the number of sensing constraints.

By considering the movement of the sensor by a mechanical mechanism and by dividing an automation task in sub tasks, valid sensor positions in the form of mount positions of a movable sensor platform may be found in accordance with the presently contemplated embodiment.

In an alternative preferred version of the above embodiment, at least one mount position is identified within the determined one or more mount positions based on one or more optimization criteria. The optimization criteria may be the same criteria as described above, e.g., the optimization criteria may refer to a short cable length or to a good accessibility of the sensor platform.

In another preferred embodiment, the one or more determined mount positions for one or more sub-tasks and/or the at least one identified mount position determined based on one or more optimization criteria are output via a user interface. Particularly, those positions are visualized on a visual user interface.

The method in accordance with the disclosed embodiments of the invention may be applied to simulated processes of different automation systems. Particularly, the automation system may be a production system for producing or manufacturing a product, e.g., an assembly line. Furthermore, the automation system may be a packaging plant or a logistic system.

It is also an object of the invention to provide an apparatus for computer-implemented determination of sensor positions in a simulated process of an automation system, where the apparatus is configured to perform the method in accordance with the disclosed embodiments of the invention or the method of one or more preferred embodiments of the invention. In other words, the apparatus comprises a computing means or computer including a processor for performing the method in accordance with the disclosed embodiments of the invention or the method in accordance with one or more preferred embodiments of the invention.

It is also an object of the invention to provide a computer program product with program code, which is stored on a machine-readable carrier, for performing the method in accordance with the disclosed embodiments of the invention or the method in accordance with one or more preferred embodiments of the invention when the program code is executed by a processor on a computer.

It is also an object of the invention to provide a computer program with program code for performing the method in accordance with the invention or the method in accordance with one or more preferred embodiments of the invention when the program code is executed by a processor on a computer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, embodiments of the invention will be de scribed in detail with respect to the accompanying drawings, in which:

FIG. 1 is a flowchart illustrating a first embodiment of the invention;

FIGS. 2 to FIG. 6 are schematic views illustrating the steps performed by the first embodiment of the invention;

FIG. 7 is a flowchart illustrating a second embodiment of the invention; and

FIG. 8 to FIG. 10 are schematic views illustrating the steps performed by the second embodiment of the invention.

### DETAILED DESCRIPTION OF THE EXEMPLARY EMBODIMENTS

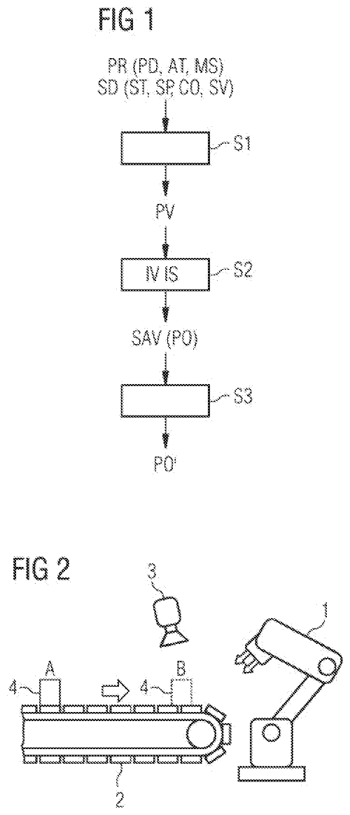

A first embodiment of the invention will be described based on a simulated process in an automation system where the simulated process refers to an automation task handled by a robot. The automation task is illustrated in FIG. 2, which shows a robot 1 at the end of a conveyor belt 2. An object 4 is transported by the conveyor belt from a position A to a position B, where the object is shown in position B by a dotted line. The robot 1 shall grip the object 4 in position B and move the object to another position.

In accordance with the first embodiment, a suitable position of a sensor 3 in the form of a camera shall be determined so that the object 4 can be detected in position B and the sensor 3 does not interfere with the robot 1. In order to determine such a position, a computer program is executed on a computer that uses digital data describing the simulated process.

With reference to FIG. 1, the simulated process is designated as PR and comprises a digital process description PD specifying the automation task AT explained above with respect to FIG. 2. The process description PD includes a movement specification MS describing the movement of the robot 1 as well as of the conveyor belt 2. The computer program receives the above process description. PD as input data. Furthermore, the computer program receives as input data a digital sensing description SD that defines a sensing task ST that refers to the detection of the object 4 at position B as shown in FIG. 2. Furthermore, the sensing description includes sensor parameters SP of the sensor 3 comprising sensing constraints CO of the sensor 3 as well as the volume SV of the sensor 3. In the embodiment described herein, the sensing constraints CO are given by a spherical shell around the object 4 in position B where the spherical shell comprises a radius (i.e., a distance to the object 4 in position B) that corresponds to the focal length of the camera. In cases in which the sensor position (e.g., the center of gravity of the sensor) is within the spherical shell, the object 4 at position B can be detected in cases in which there is no obstruction by the robot 1 or the conveyor belt 2.

Based on the above input data, the first embodiment of the invention performs step S1 of FIG. 1. In accordance with this step, a placement volume PV is calculated based on the movement specification MS, where the placement volume lies within a robot cell comprising the robot 1 and the conveyor belt 2 of FIG. 2. The placement volume PV is defined such that it does not overlap with the robot 1, the conveyor belt 2 and the object 4 during the execution of the automation task AT.

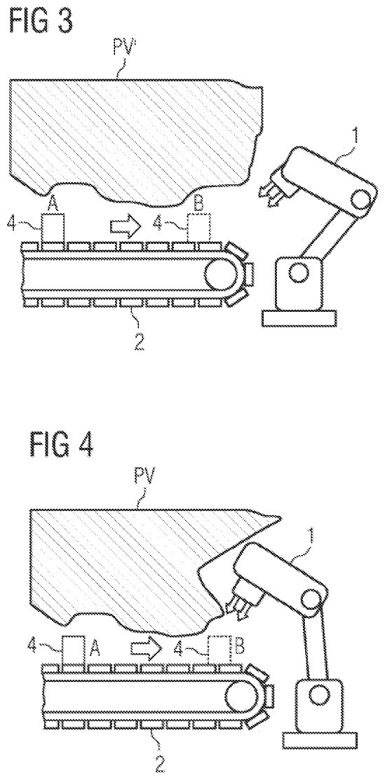

The determination of the placement volume PV is illustrated in FIG. 3 and FIG. 4. With reference to FIG. 3, at first an intermediate volume PV is calculated which is the volume with free sight on the object 4. Thereafter, the swept volume during the movement of the robot 1 is calculated and subtracted from the volume PV resulting in the placement volume PV shown in FIG. 4. The calculation of the swept volume can be performed by methods known from the prior art. For example, the kinematic chain of the moving parts of the robot may be described by a directed graph structure with rigid bodies assigned to nodes of a tree. Articulated junctions between those rigid bodies are represented by edges connecting the nodes. The nodes comprise parameters describing the respective junction. Using such a kinematic model, the swept volume is defined by the union of all geometric configurations of the rigid bodies over time.

After having calculated the placement volume PV, the method of FIG. 1 performs step S2, which determines a sensor arrangement volume SAV defining a volume of sensor positions PO of the sensor 3, where the sensor volume SV of the sensor 3 lies at each sensor position of the sensor arrangement volume SAV completely within the placement volume PV and where the sensing task ST can be performed during the execution of the automation task AT at each sensor position within the sensor arrangement volume SAP by the sensor 3 taking into account the sensing constraints CO.

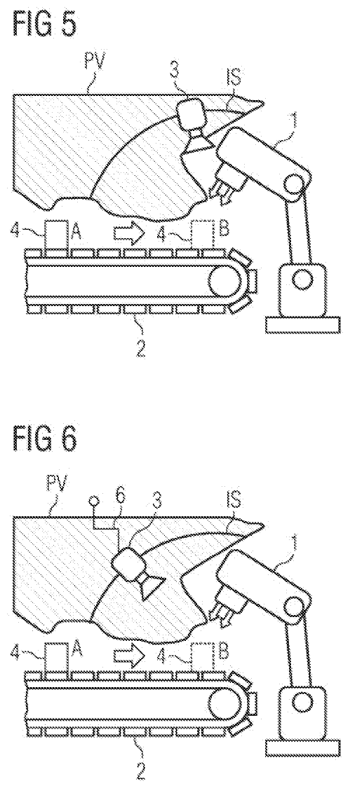

In order to calculate the sensor arrangement volume SAV, an intermediate volume IV is determined. This is illustrated in FIG. 5. The intermediate volume refers to the above described spherical shell where the part of the spherical shell within the placement volume PP is indicated by reference numeral IS in FIG. 5. After having determined the intermediate volume IV, this volume is intersected with the placement volume PV resulting in the intersection IS. At all positions within the intersection IS, the sensing task of sensing the object 4 at position B can be performed assuming that the robot 1 and the conveyor belt 2 are absent. In a next step, the sensor arrangement volume SAV comprising the positions PO is deter mined as those positions within the section IS where during the automation task AT the sensing task ST of the sensor 3 can be performed with respect to the sensing constraints CO considering the placement volume PV (i.e., no obstructions in the detection area of the sensor during sensing) and where the sensor volume SV lies completely within the placement volume PV. Those positions can be visualized on a visual or graphical user interface showing the scenario of FIG. 5 and additionally highlighting the sensor volume SAV.

Optionally, the additional step S3 shown in FIG. 1 can be performed. In accordance with this step, positions PO′ out of the positions PO of the sensor arrangement volume SAV are selected based on one or more optimization criteria. A variant of step S3 is illustrated in FIG. 6. As shown therein, the optimization criterion refers to the length of the cable 6 connecting the sensor with a plug. The optimization criterion is such that the length of the cable lies under a predetermined threshold at the respective positions PO′. Analogously to the positions PO, the positions PO′ may be visualized in an image shown on a graphical user interface, e.g., by highlighting the positions PO′ sown in the scenario of FIG. 6.

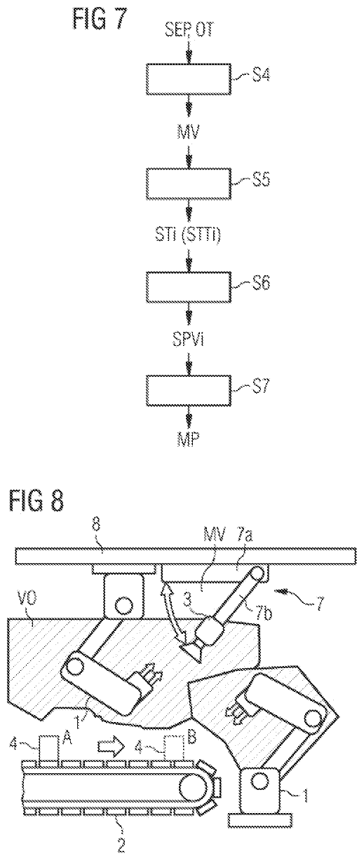

In cases in which no positions PO can be found by the method of FIG. 1, a corresponding message indicating that there are no such positions is output via a user interface. However, in another embodiment described with respect to FIG. 7, additional steps are performed in cases in which no positions PO can be found.

The steps shown in FIG. 7 are applied to the scenario shown in FIG. 8 to FIG. 10. This scenario slightly differs from the scenario of FIGS. 2 to 6 due to the fact that two robots 1 are used for handling the object 4. Nevertheless, the steps shown in FIG. 7 may analogously be applied to the scenario of FIG. 2 to FIG. 6.

As illustrated in FIGS. 8 to 10, it is assumed that the sensor 3 may be moved by a mechanical mechanism 7 that is mounted on the ceiling 8 lying above the robots 1 and the conveyor belt 2. The mechanical mechanism comprises an arm 7a attached to the ceiling as well as an arm 7b pivotally mounted to the arm 7a, where the sensor 3 is attached to the free end of the arm 7b. The sensor 3 can be positioned in a retracted or idle position, where the arm 7b extends parallel to the arm 7a so that the sensor lies adjacent to the ceiling 8. From this retracted position, the sensor 3 can be moved by rotating the arm 7b to the sensing position that is shown in each of the FIGS. 8 to 10. The movement of the sensor 3 is indicated by a double arrow in FIGS. 8 to 10. The sensor 3 and the mechanical mechanism 7 form a moveable sensor platform which is designated as SEP in FIG. 7.

A digital description of the sensor platform SEP including the idle position and the sensing position as well as an operation time OT is used as input data in step S4 of FIG. 7. The operation time is the time for moving the sensor 3 from the idle position to the sensing position, performing the sensing task by the sensor 3 in the sensing position and moving the sensor 3 back to the idle position.

In step S4 of FIG. 7, a movement volume MV of the movable sensor platform SEP is determined, where the movement volume is the volume covered by the movable sensor platform SEP during the operation time OT of the movable sensor platform.

This movement volume MV is shown in FIGS. 8 to 10 and refers to the circle segment described by the double arrow included in FIGS. 8 to 10. The movement volume MV is processed by step S5 of FIG. 7. In this step, the original automation task AT is divided into a plurality of subsequent sub-tasks that are designated as STi in FIG. 7 (i=1, . . . , N, where N is the total number of sub--tasks describing the automation task AT). Each sub-task is associated with a sub-task time STTi needed to execute the sub-task.

Those sub-tasks STi having a sub-task time STTi greater than or equal to the operation time OT are processed in step S6. In this step, a sub-task placement volume SPVi is determined for the respective sub-task based on that part of the movement specification MS that describes the movement of the robots 1 and the conveyor belt 2 during the execution of the respective sub-task. The sub-task placement volume is the volume that does not overlap with the robots 1 and the conveyor belt 2 and any other object (excluding the sensor platform) during the execution of the respective sub-task STi.

FIGS. 8 to 10 show the determination of the sub-task placement volumes for different sub-tasks. In those figures, the volume VO is the swept volume covered by both robots 1 during their movement for performing the respective sub-task. The sub-task volume is the free volume excluding the volume VO and excluding the volume of all other objects assuming that the sensor platform 7 is not present. The volume VO is different for the sub-tasks of FIGS. 8 to 10 because the performed subtasks are different.

After having determined the respective sub-task volumes SPVi, a search for mount positions MP of the mechanical mechanism 7 at the ceiling 8 is performed in step S7. In a respective mount position, the movement volume MV of the movable sensor platform lies completely within the respective sub-task placement volume SPVi and the sensing task can be performed during the execution of the respective sub-task STi by the sensor 3 with respect to the sensing constraints CO. The search for the mount position can be performed by analyzing different mount positions to evaluate whether the sensing task can be performed at the respective mount position. This step of analyzing respective mount positions uses the same methods as the determination of the sensor arrangement volume described with respect to the first embodiment. The mount positions found after having performed step S7 are designated as MP in FIG. 1. Those positions MP can be visualized on a visual or graphical user interface, e.g., in an image where the respective mount positions MP are highlighted. In cases in which no mount positions can be found, a corresponding message will appear on the user interface in order to inform the user that the sensing task cannot be performed at all.

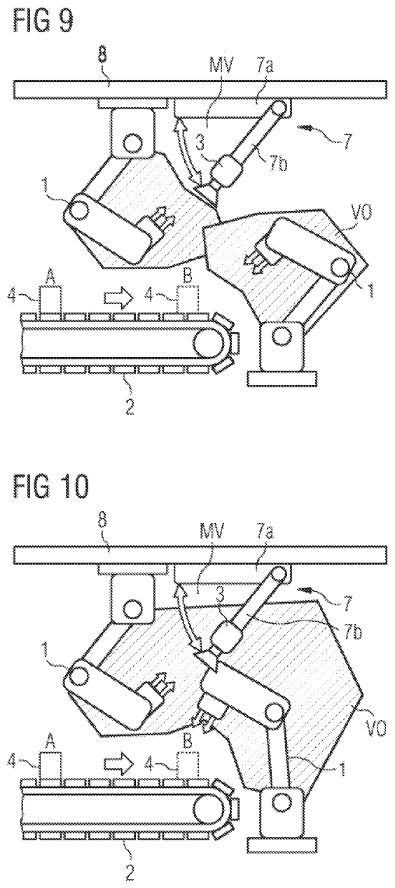

FIGS. 8 to 10 show the evaluation of one mount position with respect to the condition that the movable volume MV shall lie completely within the sub-task placement volume. Evidently, only for the sub-task of FIG. 9, this condition is fulfilled so that only the mount position in this sub-task is a candidate for a mount position MP.

The disclosed embodiments of the invention as described in the foregoing has several advantages. Particularly, a powerful decision-making model is provided that incorporates the domain knowledge of experts in a formalized way by describing a general technical method for placing sensors. The disclosed embodiments of the invention are implemented as a computer program and enables non-experts to identify possible sensor positions for a sensing task within an automation system by running the computer program.

The formalized determination of sensor locations leads to a repeatable, exact and correct solution for performing a sensing task. The proposed formalization includes technical features such as the observable state of an automation system and explicit parameters of the sensor itself, such as the focal length or the acquisition field of a camera. Furthermore, the dynamic behavior of the components of the automation system is taken into account by determining swept volumes covered by the components. The method of the invention can hardly be reproduced in such accuracy by manual engineering. Furthermore, in a preferred embodiment, it is also possible to consider the scenario of a movable sensor platform in case those static sensor locations for the sensing task cannot be found.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A method for computer-implemented determination of sensor positions in a simulated process of an automation system, the simulated process including a digital process description of an automation task to be executed by a plurality of components of the automation system, the process description including a movement specification describing a movement of the plurality of components during the execution of the automation task, and including a digital sensing description defining a sensing task to be performed by a sensor during the execution of the automation task and a plurality of sensor parameters of the sensor, and the plurality of sensor parameters comprising at least one sensing constraints of the sensor and a sensor volume of the sensor, the method comprising:
a) determining a placement volume based on the movement specification, the placement volume being within a predetermined area surrounding the plurality of components and the placement volume does not overlap with the plurality of components and any other object during the execution of the automation task; and
b) determining a sensor arrangement volume defining a volume of sensor positions of the sensor, the sensor volume of the sensor being at each sensor position within the sensor arrangement volume completely inside the placement volume and the sensing task being performable during the execution of the automation task at each sensor position within the sensor arrangement volume by the sensor with respect to the least one sensing constraints.

15. The method according to claim 14, wherein at least one sensor position is identified within the sensor arrangement volume based on at least one optimization criteria.

16. The method according to claim 14, wherein at least one of (i) the sensor arrangement volume and (ii) the at least one sensor position are output via a user interface.

17. The method according to claim 15, wherein at least one of (i) the sensor arrangement volume and (ii) the at least one sensor position e output via a user interface.

18. The method according to claim 14, wherein at east one of (i) the plurality of components comprises at least one robot and (ii) the sensor comprises at least one optical sensor for detecting at least one object handled by the plurality of components.

19. The method according to claim 14, wherein the at one optical sensor comprises at least one camera.

20. The method according to claim 4, wherein the determination of the sensor arrangement volume further comprises:
determining an intermediate volume defining a volume of sensor positions of the sensor, at each sensor position within the intermediate volume the sensing task being performable by the sensor with respect to the plurality of sensing constraints without considering the placement volume;
determining an intersection between the intermediate volume and the placement volume; and
determining as the sensor arrangement volume that area within the intersection at which the sensing task is performable by the sensor with respect to the plurality of sensing constraints considering the placement volume and at which the sensor volume lies completely within the placement volume.

21. The method according to claim 14, wherein, when a sensor arrangement volume cannot be identified when determining the sensor arrangement volume, the method further comprises:
associating with the sensor a mechanical mechanism for moving the sensor, the sensor and the mechanical mechanism forming a movable sensor platform, an operation time being assigned to the movable sensor platform, the operation being a time for moving the sensor from a first position to a second position which is a sensing position, for performing the sensing task by the sensor in the sensing position and moving the sensor back to the idle position;
determining a movement volume of the movable sensor platform, the movement volume being the volume covered by the movable sensor platform during the operation time of the movable sensor platform;
dividing the automation task into a plurality of subsequent sub-tasks, each sub-task being associated with a sub-task time needed to execute the sub-task, for each sub-task having a sub-task time greater than or equal to the operation time of the movable sensor platform, the method further comprising:
determining for the respective sub-task a sub task placement volume based on that part of the movement specification which describes the movement of the plurality of components during the execution of the respective sub-task, the subtask placement volume lies within the predetermined area surrounding the number of components and the sub-task placement volume does not overlap with the plurality of components and any other object during the execution of the respective sub-task; and
determining at least one mount position of the movable sensor platform, at each mount position the movement volume of the movable sensor platform being completely within the respective sub-task placement volume and the sensing task being performable during the execution of the respective sub-task by the sensor means with respect to the plurality of sensing constraints.

22. The method according to claim 21, wherein at least one mount position is identified within the determined at least one mount position based on at least one optimization criteria.

23. The method according to claim 21, wherein the at least one determined mount position for at least one of (i) at least one sub-tasks and (ii) the at least one identified mount position are output via a user interface.

24. The method according to claim 22, wherein the at least one determined mount position for at least one of (i) at least one sub-tasks and (ii) the at least one identified mount position are output via a user interface.

25. The method according to claim 14, wherein the automation system comprises a production system, a packaging plant or a logistic system.

26. An apparatus for computer-implemented determination of sensor positions in a simulated process of an automation system, the apparatus comprising:
a sensor; and
a plurality of components, the simulated process including a digital process description of an automation task to be executed by the plurality of components of the automation system, the process description including a movement specification describing movement of the plurality of components during the execution of the automation task, and including a digital sensing description defining a sensing task to be performed by the sensor during the execution of the automation task and a plurality of sensor parameters of the sensor, the plurality of sensor parameters comprising at least one sensing constraint of the sensor mean and a sensor volume of the sensor;
wherein the apparatus is configured to:
a) determine a placement volume based on the movement specification, the placement volume being within a predetermined area surrounding the plurality of components and the placement volume does not overlap with the number of components and any other object during the execution of the automation task; and
b) determine a sensor arrangement volume defining a volume of sensor positions of the sensor, the sensor volume of the sensor being at each sensor position within the sensor arrangement volume completely inside the placement volume and the sensing task being performable during the execution of the automation task at each sensor position within the sensor arrangement volume by the sensor with respect to the plurality of sensing constraints.

27. The apparatus according to claim 26, wherein the apparatus is configured to identify at least one sensor position within the sensor arrangement volume based on at least one optimization criteria.

28. The apparatus according to claim 26, wherein the apparatus is configured to output at least one of (i) the sensor arrangement volume and (ii) the at least one sensor position via a user interface.

29. The apparatus according to claim 27, wherein the apparatus is configured to output at least one of (i) the sensor arrangement volume and (ii) the at least one sensor position are via a user interface.

30. The apparatus according to claim 26, wherein at least one of (i) the plurality of components comprises at least one robot and (ii) the sensor comprises at least one optical sensor for detecting at least one object handled by the plurality of components.

31. The apparatus according to claim 26, wherein the at least one optical sensor comprises at least one camera.

32. The apparatus according to claim 26, wherein the apparatus is configured to determine the sensor arrangement volume by:
determining an intermediate volume defining a volume of sensor positions of the sensor, at each sensor position within the intermediate volume the sensing task being performable by the sensor with respect to the plurality of sensing constraints without considering the placement volume;
determining an intersection between the intermediate volume and the placement volume; and
determining as the sensor arrangement volume that area within the intersection at which the sensing task is performable by the sensor with respect to the plurality of sensing constraints considering the placement volume and at which the sensor volume lies completely within the placement volume.

33. The apparatus according to claim 26, wherein the apparatus is further configured such that, when a sensor arrangement volume cannot be identified when determining the sensor arrangement volume, the apparatus:
associates with the sensor a mechanical mechanism for moving the sensor, the sensor and the mechanical mechanism forming a movable sensor platform, an operation time being assigned to the movable sensor platform, the operation time being a time for moving the sensor from a first position to a second position which is a sensing position, for performing the sensing task by the sensor in the sensing position and moving the sensor back to the idle position;
determines a movement volume of the movable sensor platform, the movement volume being the volume covered by the movable sensor platform during the operation time of the movable sensor platform;
divides the automation task into a plurality of subsequent sub-tasks, each sub-task being associated with a sub-task time needed to execute the sub-task, for each sub-task having a sub-task time greater than or equal to the operation time of the movable sensor platform, the apparatus further:
determines, for the respective sub-task, a sub task placement volume based on that part of the movement specification which describes the movement of the plurality of components during the execution of the respective sub-task, the subtask placement volume lies within the predetermined area surrounding the number of components and the sub-task placement volume does not overlap with the plurality of components and any other object during the execution of the respective sub-task; and
determines at least one mount position of the movable sensor platform, at each mount position the movement volume of the movable sensor platform being completely within the respective sub-task placement volume and the sensing task being performable during the execution of the respective sub-task by the sensor means with respect to the plurality of sensing constraints.

34. The apparatus according to claim 36, wherein the apparatus is further configured to identify at least one mount position within the determined at least one mount position based on at least one optimization criteria.

35. The apparatus according to claim 36, wherein the apparatus is further configured to output the at least one determined mount position for at least one of (i) at least one sub-tasks and (ii) the at least one identified mount position via a user interface.

36. The apparatus according to claim 34, wherein the apparatus is further configured to output the at least one determined mount position for at least one of (i) at least one sub-tasks and (ii) the at least one identified mount position via a user interface.

37. The method according to claim 26, wherein the automation system comprises a production system, a packaging plant or a logistic system.

38. A non-transitory machine-readable carrier encoded with program code stored on the machine-readable carrier which, when executed by a processor of a computer causes determination of sensor positions in a simulated process of an automation system, the simulated process including a digital process description of an automation task to be executed by a plurality of components of the automation system, the process description including a movement specification describing a movement of the plurality of components during the execution of the automation task, and including a digital sensing description defining a sensing task to be performed by a sensor during the execution of the automation task and a plurality of sensor parameters of the sensor, and the plurality of sensor parameters comprising at least one sensing constraints of the sensor and a sensor volume of the sensor, the computer program code comprising:
a) computer program code for determining a placement volume based on the movement specification, the placement volume being within a predetermined area surrounding the plurality of components and the placement volume does not overlap with the plurality of components and any other object during the execution of the automation task; and
b) computer program code for determining a sensor arrangement volume defining a volume of sensor positions of the sensor, the sensor volume of the sensor being at each sensor position within the sensor arrangement volume completely inside the placement volume and the sensing task being performable during the execution of the automation task at each sensor position within the sensor arrangement volume by the sensor with respect to the least one sensing constraints.

39. A computer program with program code for carrying out the method according to claim 14 when the program code is executed on a computer.
